(19) United States
(12) Patent Application Publication
(10) Pub. No.: US 2023/0067280 A1
(43) Pub. Date: Mar. 2, 2023

(54) METHOD FOR MANUFACTURING THREE-DIMENSIONAL SHAPED OBJECT AND THREE-DIMENSIONAL SHAPING DEVICE

(71) Applicant: SEIKO EPSON CORPORATION, Tokyo (JP)

(72) Inventor: Satoshi YAMAZAKI, Matsumoto-shi (JP)

(21) Appl. No.: 17/823,342

(22) Filed: Aug. 30, 2022

(30) Foreign Application Priority Data
Aug. 31, 2021 (JP) 2021-140591

(51) Int. Cl. B29C 64/393; B29C 64/209; B29C 64/232; B29C 64/245; B33Y 30/00; B33Y 50/02

(52) U.S. Cl. CPC B29C 64/393; B29C 64/209; B29C 64/232; B29C 64/245; B33Y 30/00; B33Y 50/02; B29C 64/153

(57) ABSTRACT

Provided is a method for manufacturing a three-dimensional shaped object of shaping a three-dimensional shaped object by discharging a shaping material from a discharge unit provided in a three-dimensional shaping device to laminate a plurality of layers according to shaping data for shaping the three-dimensional shaped object layer by layer. The shaping data is generated based on shape data indicating a shape of the three-dimensional shaped object. The method for manufacturing a three-dimensional shaped object includes: a first lamination step of laminating an n-th layer, n being any integer of 2 or more; a measurement step of measuring a physical quantity of an (n−1)-th layer; a data processing step of preparing shaping data for an (n+1)-th or more layer; and a second lamination step of laminating the (n+1)-th or more layer according to the shaping data prepared in the data processing step. The data processing step includes executing a correction step of preparing the shaping data for the (n+1)-th or more layer by correcting shaping data generated in advance based on the physical quantity, or a generation step of generating the shaping data for the (n+1)-th or more layer based on the physical quantity and the shape data.

The present application is based on, and claims priority from JP Application Serial Number 2021-140591, filed Aug. 31, 2021, the disclosure of which is hereby incorporated by reference herein in its entirety.

### BACKGROUND

### 1. Technical Field

The present disclosure relates to a method for manufacturing a three-dimensional shaped object and a three-dimensional shaping device.

### 2. Related Art

Regarding manufacturing of a three-dimensional shaped object, JP-A-2019-217729 discloses a technique of correcting shaping data for an n-th layer to be shaped subsequently to an (n−1)-th layer based on data for a planar shape of the (n−1) layer measured by a measurement unit and a displacement amount of a shape of the (n−1) layer predicted by a prediction unit.

In the technique of JP-A-2019-217729, since the shaping data is corrected based on a planar shape of a shaped layer, a three-dimensional shaped object can be shaped with high accuracy even when a surrounding environment or the like changes during the shaping. However, in order to correct shaping data for a layer to be shaped immediately after a layer whose planar shape is measured, a shaping time may be prolonged depending on a waiting time until the correction of the shaping data is completed.

### SUMMARY

According to a first aspect of the present disclosure, there is provided a method for manufacturing a three-dimensional shaped object of shaping a three-dimensional shaped object by discharging a shaping material from a discharge unit provided in a three-dimensional shaping device to laminate a plurality of layers according to shaping data for shaping the three-dimensional shaped object layer by layer. The shaping data is generated based on shape data indicating a shape of the three-dimensional shaped object. The method for manufacturing a three-dimensional shaped object includes: a first lamination step of laminating an n-th layer, n being any integer of 2 or more; a measurement step of measuring a physical quantity of an (n−1)-th layer; a data processing step of preparing shaping data for an (n+1)-th or more layer; and a second lamination step of laminating the (n+1)-th or more layer according to the shaping data prepared in the data processing step. The data processing step includes executing a correction step of preparing the shaping data for the (n+1)-th or more layer by correcting shaping data generated in advance based on the physical quantity, or a generation step of generating the shaping data for the (n+1)-th or more layer based on the physical quantity and the shape data.

According to a second aspect of the present disclosure, there is provided a three-dimensional shaping device. The three-dimensional shaping device includes: a stage; a discharge unit configured to discharge a shaping material toward the stage; a position change unit configured to change a relative position between the discharge unit and the stage; a control unit configured to control the discharge unit and the position change unit according to shaping data for shaping a three-dimensional shaped object layer by layer, the shaping data being generated based on shape data indicating a shape of the three-dimensional shaped object, and configured to shape the three-dimensional shaped object on the stage by discharging the shaping material from the discharge unit to laminate a plurality of layers; and a measurement unit configured to measure a physical quantity of the layers laminated on the stage. The control unit executes a first lamination step of laminating an n-th layer, n being any integer of 2 or more, a measurement step of measuring a physical quantity of an (n−1)-th layer by the measurement unit, a data processing step of preparing shaping data for an (n+1)-th or more layer, and a second lamination step of laminating the (n+1)-th or more layer according to the shaping data prepared in the data processing step. In the data processing step, the control unit executes a correction step of preparing the shaping data for the (n+1)-th or more layer by correcting shaping data generated in advance based on the physical quantity, or a generation step of generating the shaping data for the (n+1)-th or more layer based on the physical quantity and the shape data.

### BRIEF DESCRIPTION OF THE DRAWINGS

FIG. 1 is a diagram showing a schematic configuration of a three-dimensional shaping device.

FIG. 2 is a perspective view showing a schematic configuration of a screw lower surface side.

FIG. 3 is a schematic plan view showing a barrel upper surface side which is an upper surface of a barrel.

FIG. 4 is a schematic diagram schematically showing a state in which the three-dimensional shaped object is shaped.

FIG. 5 is a flowchart of three-dimensional shaping according to a first embodiment.

FIG. 6 is a flowchart of three-dimensional shaping according to a second embodiment.

FIG. 7 is a flowchart of three-dimensional shaping according to a third embodiment.

FIG. 8 shows an example of a flowchart of three-dimensional shaping for shaping a second shaped object.

FIG. 9 shows an example of a flowchart of three-dimensional shaping according to another embodiment.

### DESCRIPTION OF EXEMPLARY EMBODIMENTS

### A. First Embodiment

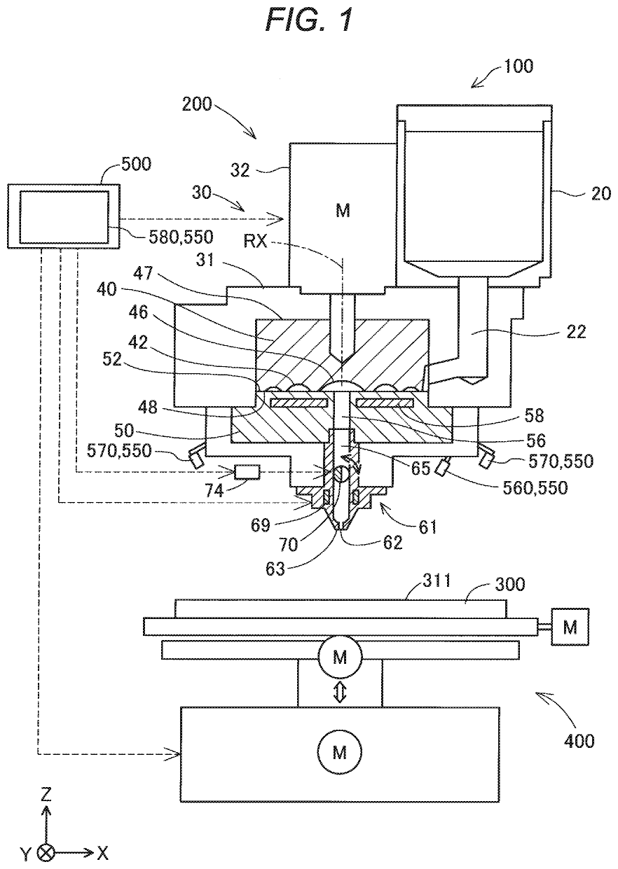

FIG. 1 is a diagram showing a schematic configuration of a three-dimensional shaping device 100 according to a first embodiment. FIG. 1 shows arrows along X, Y, and Z directions orthogonal to one another. The X, Y, and Z directions are directions along an X axis, a Y axis, and a Z axis, which are three spatial axes orthogonal to one another, and the X, Y, and Z directions each include a direction on one side along the X axis, the Y axis, or the Z axis, and a direction opposite thereto. The X axis and the Y axis are axes along a horizontal plane, and the Z axis is an axis along a vertical line. In other drawings, arrows along the X, Y, and Z directions are also shown as appropriate. The X, Y, and Z directions in FIG. 1 and the X, Y, and Z directions in other drawings indicate the same directions. Hereinafter, a +Z direction is also referred to “upper”, and a −Z direction is also referred to as “lower”.

The three-dimensional shaping device 100 includes a control unit 500 that controls the three-dimensional shaping device 100, a discharge unit 200 that generates and discharges a shaping material, a stage 300 for shaping that serves as a base for a three-dimensional shaped object, and a position change unit 400 that controls a discharge position of the shaping material.

Under the control of the control unit 500, the discharge unit 200 discharges, onto the stage 300, a pasty shaping material obtained by melting a material in a solid state. The discharge unit 200 includes a material supply unit 20 that is a supply source of the material before being converted into the shaping material, a plasticizing unit 30 that plasticizes the material to generate the shaping material, and a nozzle 61 that discharges the generated shaping material.

The material supply unit 20 contains a material in a state of pellets, powder, or the like. In the present embodiment, a resin formed in a pellet shape is used as the material. The material supply unit 20 in the present embodiment is a hopper. A supply path 22 that couples the material supply unit 20 and the plasticizing unit 30 is provided below the material supply unit 20. The material supply unit 20 supplies the material to the plasticizing unit 30 through the supply path 22.

The plasticizing unit 30 includes a screw case 31, a drive motor 32, a screw 40, and a barrel 50. The plasticizing unit 30 plasticizes at least a part of the material supplied from the material supply unit 20, generates a pasty shaping material having fluidity, and supplies the shaping material to the nozzle 61. The term “plasticizing” is a concept including melting, and refers to changing from a solid state to a fluid state. Specifically, in a case of a material in which glass transition occurs, the plasticizing refers to setting a temperature of the material to a glass transition point or higher. In a case of a material in which glass transition does not occur, the plasticizing refers to setting the temperature of the material to a melting point or higher. The screw 40 in the present embodiment may be referred to as a flat screw or a scroll.

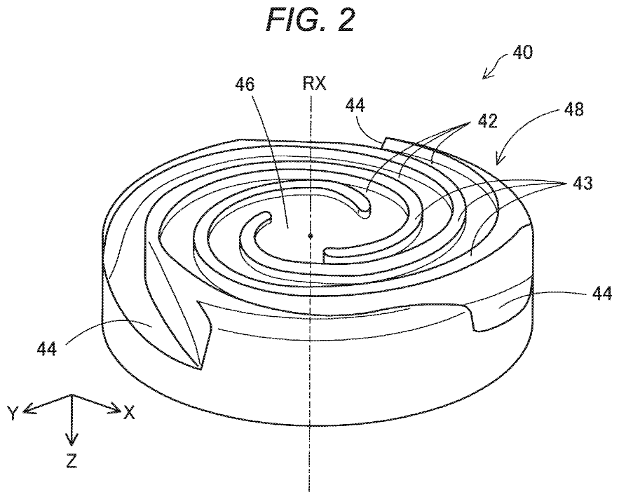

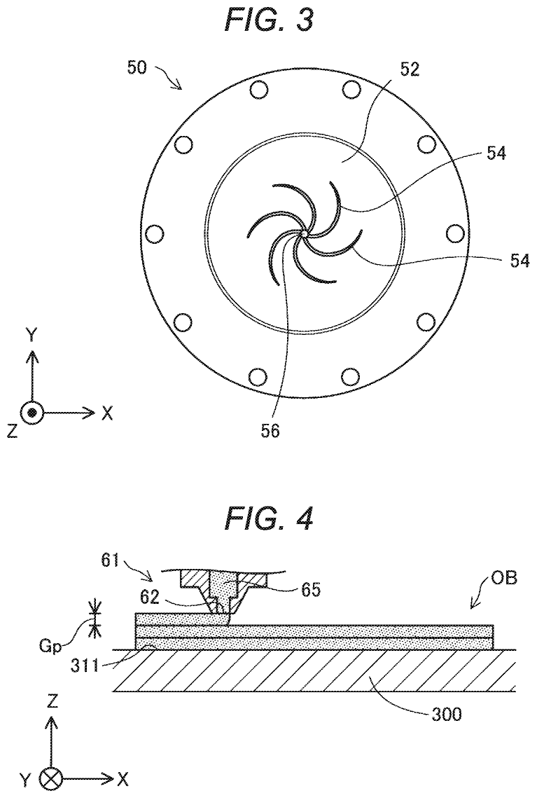

FIG. 2 is a perspective view showing a schematic configuration of a screw lower surface 48 side which is a lower surface of the screw 40. FIG. 3 is a schematic plan view showing a barrel upper surface 52 side which is an upper surface of the barrel 50. The screw 40 has a substantially cylindrical shape whose height in an axial direction, which is a direction along a central axis RX, is smaller than a diameter thereof. In the screw 40, the central axis RX, which is a rotation center of the screw 40, is parallel to the Z direction.

As shown in FIG. 1, the screw 40 is housed in the screw case 31. An upper surface 47 side of the screw 40 is coupled to the drive motor 32, and the screw 40 rotates in the screw case 31 by a rotational driving force generated by the drive motor 32. The drive motor 32 is driven under the control of the control unit 500. The screw 40 may be driven by the drive motor 32 via a speed reducer.

As shown in FIG. 2, spiral grooves 42 are formed in the screw lower surface 48. The supply path 22 of the material supply unit 20 described above communicates with the grooves 42 from a side surface of the screw 40. The grooves 42 are continuous to a material inlet 44 formed in the side surface of the screw 40. The material inlet 44 is a portion that receives the material supplied through the supply path 22 of the material supply unit 20. As shown in FIG. 2, in the present embodiment, the grooves 42 are separated by ridge portions 43 and are formed into three grooves. The number of the grooves 42 is not limited to three, and may be one, two or more. A shape of the groove 42 is not limited to a spiral shape, and may be a helical shape or an involute curve shape, or may be a shape extending so as to draw an arc from a central portion 46 toward an outer periphery.

As shown in FIG. 1, the barrel 50 is disposed below the screw 40. The barrel upper surface 52 faces the screw lower surface 48, and a space is formed between the groove 42 in the screw lower surface 48 and the barrel upper surface 52. The barrel 50 is provided with, on the central axis RX of the screw 40, a communication hole 56 communicating with a flow path 65 of a nozzle 61 to be described later. The barrel 50 is provided with a heater 58 at a position facing the groove 42 of the screw 40. A temperature of the heater 58 is controlled by the control unit 500.

The material supplied into the groove 42 of the screw 40 flows along the groove 42 by the rotation of the screw 40 while being melted in the groove 42, and is guided to the central portion 46 of the screw 40 as the shaping material. The paste-like shaping material that flows into the central portion 46 and exhibits fluidity is supplied to the nozzle 61 through the communication hole 56. In the shaping material, substances constituting the shaping material may be not all melted. The shaping material may be converted into a state having fluidity as a whole by melting at least some kinds of the substances constituting the shaping material.

As shown in FIG. 1, the nozzle 61 includes the flow path 65, a distal end surface 63 provided with a nozzle opening 62, and a discharge amount adjusting unit 70. The flow path 65 is a flow path for the shaping material formed in the nozzle 61, and is coupled to the communication hole 56 of the barrel 50 described above. The distal end surface 63 is a surface constituting a distal end portion of the nozzle 61 protruding in the −Z direction toward a shaping surface 311. The nozzle opening 62 is a portion provided at an end portion of the flow path 65 on a side communicating with the atmosphere, in which a flow path cross section of the flow path 65 is reduced. The shaping material generated by the plasticizing unit 30 is supplied to the nozzle 61 through the communication hole 56, and is discharged from the nozzle opening 62 through the flow path 65.

The discharge amount adjusting unit 70 adjusts a flow rate of the shaping material discharged from the nozzle opening 62. The flow rate of the shaping material discharged from the nozzle opening 62 to the outside may be referred to as a discharge amount. In the present embodiment, the discharge amount adjusting unit 70 is a butterfly valve that rotates in the flow path 65 to change an opening degree of the flow path 65, and is provided in the middle of the flow path 65. The discharge amount adjusting unit 70 is driven by a drive unit 74, which is a stepping motor or the like, under the control of the control unit 500. The control unit 500 controls a rotation angle of the butterfly valve using the drive unit 74, thereby adjusting the opening degree of the flow path 65. Accordingly, the control unit 500 can adjust the flow rate of the shaping material flowing from the plasticizing unit 30 to the nozzle 61 and adjust the discharge amount. The discharge amount adjusting unit 70 can also set the opening degree of the flow path 65 to 0, thereby setting the discharge amount to 0. That is, the discharge amount adjusting unit 70 adjusts the discharge amount and controls on/off of delivery of the shaping material.

In the present embodiment, the nozzle 61 is provided with a nozzle heater 69. The nozzle heater 69 in the present embodiment is provided around the flow path 65, and heats the shaping material in the flow path 65 under the control of the control unit 500. The control unit 500 can control an output of the nozzle heater 69, thereby adjusting the fluidity of the shaping material in the flow path 65.

The stage 300 is disposed at a position facing the nozzle 61. As described later, the three-dimensional shaping device 100 shapes the three-dimensional shaped object by discharging the shaping material from the nozzle 61 toward the shaping surface 311 of the stage 300 to laminate layers.

The position change unit 400 changes a relative position between the nozzle 61 and the stage 300. In the present embodiment, the position change unit 400 moves the stage 300 with respect to the nozzle 61. A change in the relative position of the nozzle 61 with respect to the stage 300 may be simply referred to as movement of the nozzle 61. In the present embodiment, for example, movement of the stage 300 in a +X direction can be rephrased as movement of the nozzle 61 in a −X direction. The position change unit 400 in the present embodiment is a three-axis positioner that moves the stage 300 in three axial directions of the X, Y, and Z directions by driving forces of three motors. The motors are driven under the control of the control unit 500. The position change unit 400 may move the nozzle 61 without moving the stage 300, instead of moving the stage 300. In addition, the position change unit 400 may move both the stage 300 and the nozzle 61.

A measurement unit 550 measures a physical quantity of the layers laminated on the shaping surface 311 of the stage 300. The measurement unit 550 in the present embodiment includes an infrared camera 560, two cameras 570, and a measurement control unit 580 that controls the infrared camera 560 and the cameras 570. The measurement control unit 580 in the present embodiment is a functional unit implemented by the control unit 500 executing a program. In the present embodiment, the measurement control unit 580 measures, as the physical quantity of the layer, a temperature of the layer as well as dimensions and positions of the portions of the layer. More specifically, the measurement control unit 580 measures the temperature of the layer based on thermography by the infrared camera 560, and measures the dimensions and the positions of the portions of the layer based on a parallax between the two cameras 570. In another embodiment, the measurement unit 550 may include, for example, a laser range finder as a sensor for measuring the dimension or the position of the layer together with the cameras 570 or instead of the cameras 570. For example, the measurement unit 550 may not include the cameras 570, and the thermography by the infrared camera 560 may be used for measuring the dimension and the position of the layer. For example, the measurement unit 550 may distinguish a layer laminated immediately before and the other layers, based on an image captured by the cameras 570 and the thermography captured by the infrared camera 560. In addition, the measurement unit 550 may measure the physical quantity of the entire layer, or may measure the physical quantity of a part of the layer.

The control unit 500 is a control device that controls an overall operation of the three-dimensional shaping device 100. The control unit 500 is a computer including one or a plurality of processors, a main storage device, and an input and output interface that receives and outputs signals from and to the outside. The control unit 500 executes various functions such as a function as the measurement control unit 580 and a function of executing three-dimensional shaping to be described later by the processor executing a program or a command read into the main storage device. The control unit 500 may be implemented by a configuration in which a plurality of circuits for implementing at least a part of the functions are combined instead of a computer.

The three-dimensional shaping refers to processing for shaping a three-dimensional shaped object. The three-dimensional shaping is executed, by the control unit 500 when a predetermined start operation is executed by a user on an operation panel provided in the three-dimensional shaping device 100 or a computer coupled to the three-dimensional shaping device 100. The three-dimensional shaping may be simply referred to as shaping.

FIG. 4 is a schematic diagram schematically showing a state in which a three-dimensional shaped object OB is shaped by the three-dimensional shaping. In the shaping, the control unit 500 controls the discharge unit 200 and the position change unit 400 as appropriate according to shaping data to be described later, discharges the shaping material from the nozzle 61 of the discharge unit 200 toward the stage 300, and laminates layers of the shaping material on the shaping surface 311 in the Z direction, thereby shaping the three-dimensional shaped object OB. Specifically, as shown in FIG. 4, the control unit 500 discharges the shaping material from the nozzle 61 while moving the nozzle 61 in a direction along the shaping surface 311. The shaping material discharged from the nozzle 61 is continuously deposited in a moving direction of the nozzle 61. Accordingly, a portion linearly extending along a movement path of the nozzle 61 is shaped. Further, the control unit 500 further discharges the shaping material on the discharged shaping material to shape the layers of the shaping material. In the shaping, the control unit 500 discharges the shaping material from the nozzle 61 while maintaining a distance between the nozzle 61 and a discharge target. The discharge target is the shaping surface 311 when the shaping material is discharged onto the shaping surface 311, and is an upper surface of the discharged shaping material when the shaping material is discharged onto the discharged shaping material. The distance between the nozzle 61 and the discharge target may be referred to as a gap Gp.

The shaping data is data for shaping the three-dimensional shaped object layer by layer, and includes path data and discharge amount information. The path data refers to data indicating a path along which the discharge unit 200 moves while discharging the shaping material by a plurality of partial paths. The discharge amount information refers to information indicating the discharge amount of the shaping material in each partial path. The shaping data is generated based on shape data for the three-dimensional shaped object. The shape data refers to data indicating the shape of the three-dimensional shaped object, and is, for example, three-dimensional CAD data.

The path data in the present embodiment specifies a linear partial path indicating a path along which the nozzle 61 moves and discharges the shaping material. The discharge amount information specifies a lamination pitch and a line width in each partial path. The lamination pitch refers to a thickness of the shaping material discharged in each partial path. The line width refers to a width of the shaping material discharged in each partial path. The lamination pitch and the line width are determined by a size of the gap Gp and an amount of the shaping material discharged from the nozzle 61 per unit movement amount. For example, when the gap Gp is small, the shaping material discharged from the nozzle 61 is more pressed against the discharge target by the nozzle 61 than when the gap Gp is large, and therefore, the lamination pitch is smaller and the line width is larger. The amount of the shaping material discharged from the nozzle 61 per unit movement amount is determined by, for example, a movement speed of the nozzle 61 and an amount of the shaping material discharged from the nozzle 61 per unit time. The amount of the shaping material discharged from the nozzle 61 per unit time is determined by, for example, an opening diameter of the nozzle opening 62 and the flow rate of the shaping material flowing in the nozzle 61.

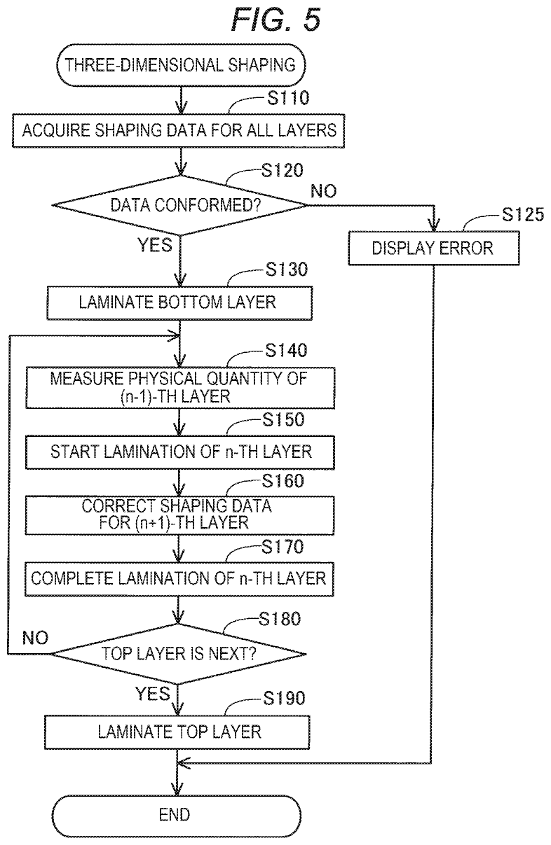

FIG. 5 is a flowchart of the three-dimensional shaping for implementing a method for manufacturing a three-dimensional shaped object according to the present embodiment. In step S110, the control unit 500 acquires the shaping data for all layers. In step S110, the control unit 500 acquires the shaping data by, for example, communicating with an external computer.

In step S120, the control unit 500 executes a determination step of determining whether the shaping data conforms to the three-dimensional shaping device 100. As shown in FIG. 5, the determination step of step S120 is executed before a step of step S130 and a first lamination step of step S150 to step S170, which will be described later. In the present embodiment, in step S120, for example, the control unit 500 analyzes the number of nozzles and a shaping method required for shaping a three-dimensional shaped object according to the shaping data acquired in step S110, and determines that the shaping data conforms to the three-dimensional shaping device 100 when the number of nozzles and the shaping method coincide with the number of the nozzle 61 and a shaping method of the three-dimensional shaping device 100. In another embodiment, for example, when specific identification information is included in a header portion or the like of the shaping data, the control unit 500 may determine that the shaping data conforms to the three-dimensional shaping device 100.

When it is determined in step S120 that the shaping data does not conform to the three-dimensional shaping device 100, the control unit 500 advances the processing to step S125, displays an error on a notification unit (not shown), which is a speaker, a liquid crystal monitor, or the like, and notifies the user that the shaping data does not conform to the three-dimensional shaping device 100. Thereafter, the control unit 500 ends the three-dimensional shaping. In another embodiment, when it is determined in step S120 that the shaping data does not conform to the three-dimensional shaping device 100, for example, the control unit 500 may return the processing to step S110 and acquire shaping data different from the shaping data acquired previously.

In step S130, the control unit 500 laminates a bottom layer of the three-dimensional shaped object. In step S130, the control unit 500 controls the discharge unit 200 and the position change unit 400 according to the shaping data for shaping a first layer that is included in the shaping data acquired in step S110, thereby laminating the bottom layer.

After step S140, the control unit 500 repeats the steps from step S140 to step S170 as one cycle to laminate layers from a second layer to a layer immediately below a top layer in the three-dimensional shaped object. In the present embodiment, the control unit 500 laminates one layer of the three-dimensional shaped object in each cycle. Hereinafter, a cycle in which the n-th layer of the three-dimensional shaped object is laminated may be referred to as an n-th cycle, n being an integer of 2 or more. That is, in the n-th cycle, the control unit 500 laminates the n-th layer as a current layer. For example, when step S140 is executed for the first time after the start of the three-dimensional shaping, a second cycle is started in step S140, and the second layer is laminated as the current layer.

In step S140, the control unit 500 controls the measurement unit 550, thereby measuring a physical quantity of an (n−1)-th layer shaped before the n-th layer. That is, in step S140, the control unit 500 measures a physical quantity of a layer immediately before the current layer. For example, in step S140 in the second cycle, a physical quantity of the first layer is measured. Similarly, in step S140 in a third cycle, a physical quantity of the second layer is measured. Hereinafter, a step of measuring the physical quantity of the (n−1)-th layer as in step S140 may be referred to as a measurement step.

In step S150, the control unit 500 starts lamination of the n-th layer, which is the current layer. During a period after step S150 and before the lamination of the n-th layer in step S170 to be described later is completed, the control unit 500 controls the discharge unit 200 and the position change unit 400 according to the shaping data for shaping the n-th layer, thereby laminating the n-th layer. Hereinafter, the shaping data for laminating the n-th layer may be simply referred to as “shaping data for the n-th layer”. Similarly, the shaping data for laminating the first layer may be referred to as “shaping data for the first layer”, and the shaping data for laminating the top layer may be referred to as “shaping data for the top layer”. In addition, the step of laminating the n-th layer, such as step S150 to step S170 in the n-th cycle, may be referred to as the first lamination step.

In step S150 to step S170 of the second cycle, the control unit 500 shapes the second layer according to the shaping data for the second layer that is included in the shaping data acquired in step S110. On the other hand, in step S150 to step S170 in the third and subsequent cycles, the control unit 500 shapes the n-th layer according to the shaping data prepared in step S160 of an (n−1)-th cycle to be described later. For example, in the third cycle, the control unit 500 shapes the third layer according to the shaping data prepared in the second cycle.

In step S160, the control unit 500 executes a data processing step. The data processing step refers to a step of preparing shaping data for an (n+1)-th or more layer, which is a layer after the current layer. In the present embodiment, the control unit 500 executes a correction step in the data processing step of step S160. The correction step refers to a step of preparing the shaping data for the (n+1)-th or more layer by correcting the shaping data generated in advance based on a measurement value of the physical quantity. In the present embodiment, the control unit 500 merely prepares the shaping data for one layer in the data processing step.

More specifically, in the present embodiment, in step S160, the control unit 500 corrects the shaping data for the (n+1)-th layer acquired in step S110 based on a measurement value of the physical quantity of the (n−1)-th layer measured in step S140, thereby preparing the shaping data for the (n+1)-th layer. For example, in step S160 of the second cycle, the control unit 500 corrects the shaping data for the third layer acquired in step S110 based on a measurement value of the physical quantity of the first layer that is shaped according to the shaping data acquired in step S110, thereby preparing the shaping data for the third layer. In step S160 of a fourth cycle, the control unit 500 corrects the shaping data for shaping a fifth layer based on a measurement value of a physical quantity of the third layer laminated according to the shaping data prepared in step S160 of the second cycle, thereby preparing the shaping data for the fifth layer.

In the present embodiment, in the second cycle and the third cycle, the control unit 500 corrects, in the correction step of step S160, the shaping data for the (n+1)-th layer acquired in step S110 based on a difference between a measured shape and a predicted shape of the (n−1)-th layer. The measured shape refers to a shape of a layer calculated based on the measurement value of the physical quantity. The predicted shape refers to a shape of a layer predicted based on the shaping data. In the present embodiment, the predicted shape is predicted based on the shaping data acquired in step S110. The measured shape and the predicted shape may be shapes of any portions corresponding to each other, and may be shapes of portions of a layer, respectively. For example, in step S160, when a dimension of an outline of the (n−1)-th layer calculated based on the measurement value of the physical quantity is larger than a predicted dimension of the outline of the (n−1)-th layer, the control unit 500 corrects the shaping data for the (n+1)-th layer so that an outline of the (n+1)-th layer shaped according to shaping data after correction is smaller than an outline of the (n+1)-th layer shaped according to the shaping data before correction. In this case, for example, the control unit 500 corrects the shaping data by multiplying a length of the partial path or the discharge amount that is included in the shaping data for the (n+1)-th layer before correction by a correction coefficient calculated based on the difference between the measured shape and the predicted shape of the (n−1)-th layer.

After the fourth cycle, in step S160, the control unit 500 corrects the shaping data for the (n+1)-th layer based on the difference between the measured shape and the predicted shape of the (n−1)-th layer and a difference between shaping data for the (n−1)-th layer after correction and the shaping data for the (n−1)-th layer before correction. For example, shaping data for the fifth layer after correction is shaping data obtained by correcting the shaping data for the fifth layer before correction acquired in step S110 based on a difference between a measured shape and a predicted shape of the third layer and a difference between the shaping data for the third layer after correction and the shaping data for the third layer before correction. As described above, the shaping data for the third layer after the correction is shaping data obtained by correcting the shaping data for the third layer before the correction based on a difference between a measured shape and a predicted shape of the first layer. Therefore, it can be said that the shaping data for the fifth layer is corrected based on the difference between the measured shape and the predicted shape of the third layer and the difference between the measured shape and the predicted shape of the first layer.

The above difference between the measured shape and the predicted shape is caused by, for example, a change in an actual amount, position, temperature, and the like of the discharged shaping material due to a change in a shaping environment such as temperature and humidity, deterioration over time of the discharge unit 200, or the like. By executing the correction step of step S160, even when there is a change in the shaping environment, deterioration over time of the discharge unit 200, or the like, it is possible to increase the possibility that the three-dimensional shaped object can be shaped with high accuracy.

The shaping data for the (n+1)-th or more layer prepared in the data processing step of step S160 is used for shaping the (n+1)-th or more layer in a cycle after the n-th cycle. In the present embodiment, the shaping data for the (n+1)-th layer prepared in step S160 of the n-th cycle is used for shaping the (n+1)-th layer in step S150 to step S170 of an (n+1)-th cycle. Thus, the step of laminating the (n+1)-th or more layer according to the shaping data prepared in the data processing step may be referred to as a second lamination step. In the present embodiment, for example, when the current cycle is the second cycle, the steps of step S150 to step S170 of the second cycle are the first lamination step, and the steps of step S150 to step S170 of the third cycle are the second lamination step. Similarly, when the current cycle is the third cycle, the steps of steps S150 to S170 in the third cycle are the first lamination step, and the steps of steps S150 to S170 in the fourth cycle are the second lamination step.

In step S170, the control unit 500 completes the shaping of the n-th layer. That is, in the present embodiment, the control unit 500 completes the above data processing step of step S160 during the execution of the first lamination step, that is, during a period from the start to the completion of the lamination of the n-th layer which is the current layer.

In step S180, the control unit 500 determines whether the layer to be shaped next is the top layer. When it is determined in step S180 that the layer to be shaped next is not the top layer, the control unit 500 returns the processing to step S140 and starts the next cycle.

When it is determined in step S180 that the layer to be shaped next is the top layer, the control unit 500 shapes the top layer in step S190. In step S190, the control unit 500 shapes the top layer according to the shaping data for shaping the top layer prepared in step S160 executed immediately before. For example, when the top layer is a 10th layer, the control unit 500 shapes the 10th layer according to shaping data corrected in step S160 of a ninth cycle.

According to the above method for manufacturing a three-dimensional shaped object in the present embodiment, the method includes the first lamination step of laminating the n-th layer, the measurement step of measuring the physical quantity of the (n−1)-th layer, the data processing step of preparing the shaping data for the (n+1)-th or more layer, and the second lamination step of laminating the (n+1)-th or more layer according to the shaping data prepared in the data processing step. The data processing step includes executing the correction step of preparing the shaping data for the (n+1)-th or more layer by correcting the predetermined shaping data based on the measurement value of the physical quantity. Accordingly, since the n-th layer can be shaped during the preparation of the shaping data for the (n+1)-th or more layer, the waiting time until the preparation of the shaping data is completed can be reduced as compared with when the shaping data for the n-th layer is prepared based on the measurement value of the physical quantity. Therefore, it is possible to increase the possibility that the three-dimensional shaped object can be shaped with high accuracy, and to prevent prolongation of the shaping time.

In the present embodiment, the data processing step is completed during the execution of the first lamination step. Therefore, the waiting time until the preparation of the shaping data is completed can be further reduced, and the prolongation of the shaping time can be further prevented.

The present embodiment further includes a determination step of determining, before the first lamination step is executed, whether the shaping data conforms to the three-dimensional shaping device 100. Therefore, the three-dimensional shaped object can be shaped using the shaping data conforming to the three-dimensional shaping device 100.

In the present embodiment, in one data processing step, the shaping data for one layer is prepared as the shaping data for the (n+1)-th or more layer. Therefore, the waiting time until the preparation of the shaping data is completed can be reduced as compared with when the shaping data for a plurality of layers is prepared in one data processing step.

### B. Second Embodiment

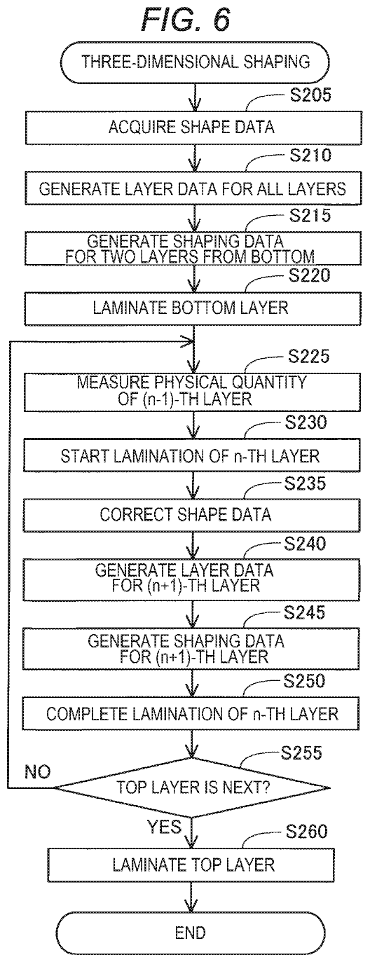

FIG. 6 is a flowchart of three-dimensional shaping for implementing a method for manufacturing a three-dimensional shaped object according to a second embodiment. In the present embodiment, in the data processing step, the control unit 500 executes a generation step instead of the correction step to prepare shaping data for the (n+1)-th or more layer. The generation step refers to a step of generating the shaping data for the (n+1)-th or more layer based on the measurement value of the physical quantity of the (n−1)-th layer and the shape data for the three-dimensional shaped object. Parts of the configuration of the three-dimensional shaping device 100 according to the present embodiment that are not particularly described are the same as those according to the first embodiment.

In step S205, the control unit 500 acquires the shape data for the three-dimensional shaped object. Hereinafter, the shape data acquired in step S205 may be referred to as “first shape data”.

In step S210, the control unit 500 generates, based on the shape data acquired in step S205, layer data obtained by slicing the shape of the three-dimensional shaped object indicated by the shape data into layers. In the present embodiment, in step S210, the control unit 500 generates layer data for all layers from the bottom layer to the top layer of the three-dimensional shaped object so that shapes indicated by the layer data have the same thickness. A lamination pitch specified in discharge amount information of the shaping data is determined by the thickness indicated by the layer data. Hereinafter, the layer data indicating the shape of the portion corresponding to the n-th layer of the three-dimensional shaped object may be simply referred to as “layer data for the n-th layer”. Similarly, the layer data indicating the shape of the first layer or the shape of the top layer may be simply referred to as “layer data for the first layer” or “layer data for the top layer”.

In step S215, the control unit 500 generates shaping data for the bottom layer and shaping data for a second layer. In step S215, the control unit 500 determines the path data and the discharge amount data for shaping the shape indicated by the layer data for the first layer as well as the path data and the discharge amount data for shaping the shape indicated by the layer data for the second layer among the layer data generated in step S210, thereby generating the shaping data.

In the present embodiment, the path data and the discharge amount data that are included in the shaping data are determined based on the layer data for the layer and the shaping condition for the three-dimensional shaped object. The shaping condition in the present embodiment includes a set temperature of the nozzle heater 69 and an internal filling rate in each layer of the three-dimensional shaped object. For example, as the set temperature of the nozzle heater 69 increases, fluidity of the shaping material discharged from the nozzle 61 increases, and more shaping materials are discharged per unit time. Therefore, for example, the control unit 500 determines the discharge amount data such that the discharge amount of the shaping material in each partial path decreases as the set temperature of the nozzle heater 69 increases. In addition, the control unit 500 determines the path data such that a distance or the number of partial paths for filling the inside of an outline of each layer increases as the internal filling rate increases. In another embodiment, the shaping condition may include another condition, and may include, for example, cooling time indicating waiting time for cooling laminated layers, or may include a set value of an output of a cooling mechanism such as a cooling fan for cooling the laminated layers, when the three-dimensional shaping device 100 includes such cooling mechanism.

In step S220, the control unit 500 shapes the bottom layer according to the shaping data for shaping the bottom layer generated in step S215.

After step S225, the control unit 500 repeats steps from step S225 to step S250 as one cycle, similar to the repetition of the steps from step S140 to step S170 in FIG. 5 as one cycle in the first embodiment, thereby shaping the three-dimensional shaped object from the second layer to the layer immediately below the top layer.

Step S225 is the same as step S140 in FIG. 5. In step S230, the control unit 500 starts lamination of the n-th layer as a current layer. Hereinafter, step S230 to step S250 in the n-th cycle may be referred to as the first lamination step, similar to step S150 to step S170 in the n-th cycle in FIG. 5 described in the first embodiment. In step S230 to step S250 of the second cycle, the control unit 500 shapes the second layer according to the shaping data for shaping the second layer generated in step S215. On the other hand, in a lamination step after the third cycle, the control unit 500 shapes the n-th layer according to the shaping data prepared in the (n−1)-th cycle to be described later.

Step S235 to step S245 in the present embodiment correspond to the above generation step of the data processing step. Hereinafter, step S235 to step S245 may be simply referred to as the data processing step or the generation step. In the present embodiment, similar to the first embodiment, the control unit 500 only prepares the shaping data for the (n+1)-th layer as the shaping data in the data processing step of the n-th cycle.

In step S235, the control unit 500 corrects the first shape data acquired in step S205 based on the measurement value of the physical quantity of the (n−1)-th layer measured in step S225. In the present embodiment, as described later, the shape data for the n-th cycle corrected in step S235 is used for generating the shaping data for the (n+1)-th layer. In step S235 of the second cycle and the third cycle, the control unit 500 corrects all shape data acquired in step S205 based on the difference between the measured shape and the shape indicated by the data for the (n−1)-th layer. In the present embodiment, the shape indicated by the data refers to the shape indicated by the layer data generated in step S210. Similar to the predicted shape described in the first embodiment, the shape indicated by the data may be a shape of any portion corresponding to the measured shape, and may be a shape of a portion of the layer. For example, in step S235, when a dimension of an outline of the (n−1)-th layer calculated based on the measurement value of the physical quantity is larger than a dimension of an outline of the shape of the (n−1)-th layer indicated by the layer data, the control unit 500 corrects the first shape data so that a shape indicated by shape data after correction is smaller than a shape indicated by the first shape data. In this case, the control unit 500 corrects the first shape data, for example, by multiplying the first shape data by a correction coefficient calculated based on a difference between a measured shape and a shape indicated by the data. Similar to the difference between the measured shape and the predicted shape described in the first embodiment, the difference between the measured shape and the shape indicated by the data is caused by, for example, a change in a shaping environment, or deterioration over time of the discharge unit 200.

In step S235 after a fourth cycle, the control unit 500 corrects the first shape data based on a difference between the first shape data and shape data used for generating shaping data for the (n−1)-th layer, that is, a difference between the first shape data and the shape data corrected in step S235 of the (n−2)-th cycle, in addition to the difference between the measured shape and the shape indicated by the data for the (n−1)-th layer. For example, in the fourth cycle, in step S235, the control unit 500 corrects the first shape data based on a difference between a measured shape and a shape indicated by data for a third layer and a difference between the first shape data and shape data corrected in step S235 of the second cycle in order to generate shaping data for a fifth layer in step S245 to be described later. As described above, the shape data corrected in step S235 of the second cycle is shape data corrected based on a difference between a measured shape and a shape indicated by the data for the first layer. Therefore, it can be said that in step S235 of the fourth cycle, the first shape data is corrected based on the difference between the measured shape and the shape indicated by the data for the third layer as well as the difference between the measured shape and the shape indicated by the data for the first layer.

In another embodiment, the above shape indicated by the data may not be the shape indicated by the layer data, and may be, for example, the shape of a portion corresponding to the measured shape among the shape indicated by the first shape data. In this case, the control unit 500 may not generate the layer data for all layers in step S210, and may, for example, only generate the layer data for the first layer and the layer data for the second layer.

In step S240, the control unit 500 generates layer data for the (n+1)-th or more layer based on the shape data corrected in step S235. In the present embodiment, the control unit 500 merely generates the layer data for the (n+1)-th layer in step S240. In step S240, the control unit 500 generates the layer data for the (n+1)-th layer based on the corrected shape data, similar to generation of layer data based on shape data not corrected in step S210.

In the present embodiment, in step S240, the control unit 500 determines, based on the measurement value of the physical quantity measured in step S225, the thickness indicated by the layer data generated in step S240. In the present embodiment, the control unit 500 determines the thickness indicated by the layer data for the (n+1)-th layer according to a change in a dimension in a Z direction indicated by the shape data that is caused by the correction executed in step S235. For example, when the shape data is corrected so as to increase the dimension of the shape in the Z direction that is indicated by the shape data in step S235, the control unit 500 sets, in step S240, the thickness indicated by the layer data for the (n+1)-th layer to be larger than a thickness indicated by the layer data for each layer generated in step S210.

In step S245, the control unit 500 generates the shaping data for the (n+1)-th or more layer based on the layer data generated in step S240. In the present embodiment, in step S245, the control unit 500 determines the path data and the discharge amount data for shaping the shape indicated by the layer data for the (n+1)-th layer based on the layer data for the (n+1)-th layer generated in step S240, thereby generating the shaping data for the (n+1)-th layer.

Step S250 and step S255 are the same as step S170 and step S180 in FIG. 5, respectively. When it is determined in step S255 that the layer to be shaped next is not the top layer, the control unit 500 returns the processing to step S225 and starts the next cycle.

According to the above method for manufacturing a three-dimensional shaped object according to the present embodiment, since the n-th layer can be shaped during the preparation of the shaping data for the (n+1)-th or more layer, the waiting time until the preparation of the shaping data is completed can be reduced as compared with when the shaping data for the n-th layer is prepared based on the measurement value of the physical quantity of the (n−1)-th layer. Therefore, it is possible to increase the possibility that the three-dimensional shaped object can be shaped with high accuracy, and to prevent prolongation of the shaping time. In particular, in the present embodiment, in the data processing step, the shaping data for the (n+1)-th or more layer is generated based on the measurement value of the physical quantity and the shape data for the three-dimensional shaped object. Accordingly, since the shaping data for the (n+1)-th or more layer can be newly generated based on the measurement value of the physical quantity, it is possible to increase the possibility that the shaping data capable of shaping a three-dimensional shaped object having a desired shape can be prepared as compared with when the shaping data for the (n+1)-th or more layer is prepared by correcting the shaping data.

In the present embodiment, the shape data is corrected based on the measurement value of the physical quantity, the layer data is generated based on the corrected shape data, and the shaping data for the (n+1)-th or more layer is generated based on the generated layer data. Accordingly, since the shape data is corrected based on the measurement value of the physical quantity, it is possible to further increase the possibility that the shaping data capable of shaping a three-dimensional shaped object having a desired shape can be prepared.

In the present embodiment, in the generation step, the thickness of the shape indicated by the layer data is determined based on the measurement value of the physical quantity. Therefore, it is possible to further improve the shaping accuracy in the Z direction of the three-dimensional shaped object.

### C. Third Embodiment

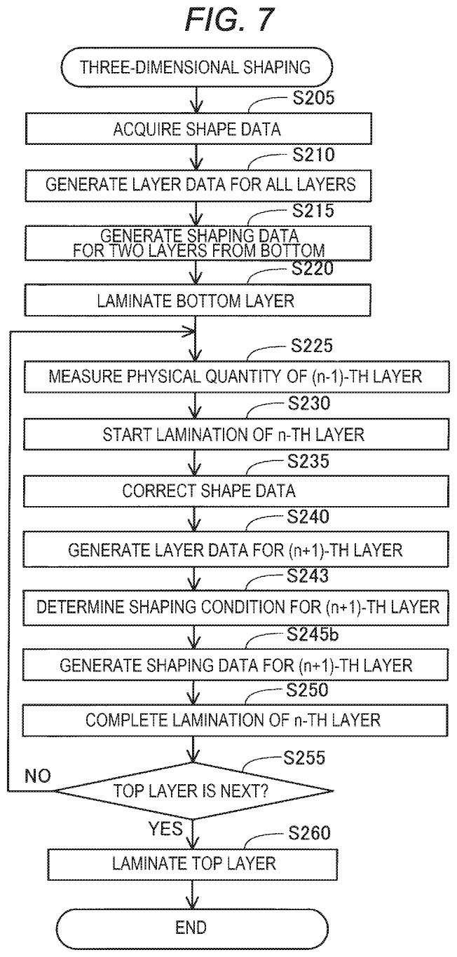

FIG. 7 is a flowchart of three-dimensional shaping for implementing a method for manufacturing a three-dimensional shaped object according to a third embodiment. In the present embodiment, different from the second embodiment, in the generation step, the control unit 500 determines the shaping condition for the (n+1)-th or more layer based on the measurement value of the physical quantity of the (n−1)-th layer, and generates shaping data for the (n+1)-th or more layer based on the shape data and the determined shaping condition. In FIG. 7, the same steps as those in FIG. 6 are denoted by the same reference numerals as those in FIG. 6. Parts of the configuration of the three-dimensional shaping device 100 according to the present embodiment, which are not particularly described, are the same as those according to the second embodiment.

In step S243, the control unit 500 determines the shaping condition for the (n+1)-th or more layer based on the measurement value of the physical quantity of the (n−1)-th layer. In the present embodiment, the control unit 500 determines the shaping condition for the (n+1)-th layer based on the physical quantity of the (n−1)-th layer measured in step S225. For example, when the measurement value of the temperature of the (n−1)-th layer measured in step S225 is lower than the predicted value, the control unit 500 sets, based on the difference between the measurement value and the predicted value, the set temperature of the nozzle heater 69 during shaping of the (n+1)-th layer to be higher than the set temperature of the nozzle heater 69 during shaping of the (n−1)-th layer. In addition, for example, when deformation of the (n−1)-th layer is detected in step S225, the control unit 500 determines the internal filling rate at the time of shaping the (n+1)-th layer so as to prevent the deformation of the (n+1)-th layer. For example, when deflection of the (n−1)-th layer is detected in step S225, the internal filling rate at the time of shaping the (n+1)-th layer is set to be higher than the internal filling rate at the time of shaping the (n−1)-th layer based on a degree of the deflection. The degree of deflection is calculated, for example, based on a dimension of the (n−1)-th layer and a position of an edge portion, which are measured as the physical quantity of the (n−1)-th layer by the measurement unit 550. In another embodiment, for example, the control unit 500 may determine a pattern of a partial path for shaping an internal shape of the (n−1)-th layer so as to prevent the deformation of the (n+1)-th layer. As described in the second embodiment, when the shaping condition includes cooling time and an output value of a cooling mechanism, the control unit 500 may determine, in step S243, the cooling time and the output value of the cooling mechanism based on the temperature of the (n−1)-th layer measured in step S225.

In step S245b, the control unit 500 generates the shaping data for the (n+1)-th or more layer. In the present embodiment, in step S245b, the control unit 500 determines path data and discharge amount information that are included in the shaping data for the (n+1)-th layer based on the shaping condition determined in step S243, and generates the shaping data for the (n+1)-th layer. For example, in step S245b, the control unit 500 determines a partial path for shaping the (n+1)-th layer and determines the path data based on the internal filling rate determined in step S243. In addition, in step S245b, the control unit 500 determines the discharge amount included in the shaping data for the (n+1)-th layer based on the set temperature of the nozzle heater 69 determined in step S243. For example, when the set temperature of the nozzle heater 69 during the shaping of the (n+1)-th layer is increased in step S243, the control unit 500 decreases, based on the set temperature, the number of rotations or a set pressure of the screw 40 that is included in the shaping data for the (n+1)-th layer.

Thereafter, in step S230 to step S250 of the (n+1)-th cycle, the control unit 500 shapes the (n+1)-th layer under the shaping condition determined in step S243 of the n-th cycle and according to the shaping data generated in step S245b of the n-th cycle.

According to the above method for manufacturing a three-dimensional shaped object in the present embodiment, the shaping condition for the (n+1)-th or more layer is determined based on the measurement value of the physical quantity of the (n−1)-th layer, and the shaping data for the (n+1)-th or more layer is generated based on the shape data for the three-dimensional shaped object and the determined shaping condition. Therefore, the shaping condition can be changed based on the measurement value of the physical quantity, and the three-dimensional shaped object can be shaped with high accuracy under the changed shaping condition.

In another embodiment, in the generation step, for example, the control unit 500 may not correct the shape data. In this case, for example, in the generation step, the control unit 500 may determine the shaping condition based on the measurement value of the physical quantity of the (n−1)-th layer without correcting the shape data, and may generate the shaping data for the (n+1)-th or more layer based on the uncorrected shape data and the determined shaping condition.

### D. Fourth Embodiment

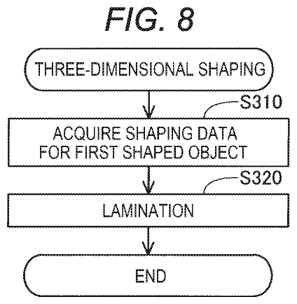

FIG. 8 is an example of a flowchart of three-dimensional shaping for shaping a second shaped object according to a fourth embodiment. In the fourth embodiment, the control unit 500 continuously executes the three-dimensional shaping twice to manufacture, as three-dimensional shaped objects, a first shaped object and a second shaped object having a shape corresponding to the first shaped object. The second shaped object is shaped after the first shaped object is shaped. In the present embodiment, the first shaped object and the second shaped object have the same shape and the same dimension in each portion. Parts of the configuration of the three-dimensional shaping device 100 according to the present embodiment that are not particularly described are the same as those according to the first embodiment.

In the present embodiment, shaping data used for manufacturing the first shaped object is used for manufacturing the second shaped object. For example, the control unit 500 first executes the three-dimensional shaping in FIG. 5, thereby shaping and manufacturing the first shaped object while executing the first lamination step, the second lamination step, the measurement step, and the data processing step. After completing the shaping of the first shaped object, the control unit 500 executes the three-dimensional shaping in FIG. 8, and acquires the shaping data actually used for manufacturing the first shaped object in step S310. More specifically, in step S310, the control unit 500 acquires uncorrected shaping data for a first layer and a second layer of the first shaped object and shaping data for third and subsequent layers of the first shaped object that is corrected based on a measurement value of a physical quantity. Next, in step S320, the control unit 500 laminates the shaping material on the shaping surface 311 of the stage 300 according to the shaping data acquired in step S310, and shapes and manufactures the second shaped object. That is, in the present embodiment, the control unit 500 uses the shaping data used for manufacturing the first shaped object as it is for manufacturing the second shaped object without correcting the shaping data.

According to the above method for manufacturing a three-dimensional shaped object according to the present embodiment, the shaping data used for manufacturing the first shaped object is used for manufacturing the second shaped object, which has a shape corresponding to the first shaped object. Accordingly, it is possible to increase the possibility that the second shaped object can be manufactured with high accuracy as compared with when the second shaped object is manufactured without using the shaping data for the first shaped object. In particular, in the present embodiment, since the shaping data used for manufacturing the first shaped object is used as it is for manufacturing the second shaped object without being corrected, the second shaped object can be manufactured efficiently.

In another embodiment, for example, the three-dimensional shaping in FIG. 5 may be executed when the second shaped object is manufactured using the shaping data used for manufacturing the first shaped object. In this case, by acquiring the shaping data used for manufacturing the first shaped object in step S110 in FIG. 5, the second shaped object can be manufactured while further correcting the shaping data, and therefore, it is possible to increase the possibility that the second shaped object can be manufactured with high accuracy. When the first shaped object is manufactured, for example, the three-dimensional shaping in FIGS. 6 and 7 may be executed instead of the three-dimensional shaping in FIG. 5.

In another embodiment, the first shaped object and the second shaped object may not have the same shape. For example, the first shaped object and the second shaped object may be similar shaped objects, or the second shaped object may be a shaped object obtained by enlarging or reducing the first shaped object at a certain magnification in an X direction, a Y direction, and a Z direction. In this case, for example, the control unit 500 may correct the shaping data used for manufacturing the first shaped object based on a ratio of dimensions of the first shaped object and the second shaped object, and use the shaping data corrected based on the ratio of the dimensions for manufacturing the second shaped object.

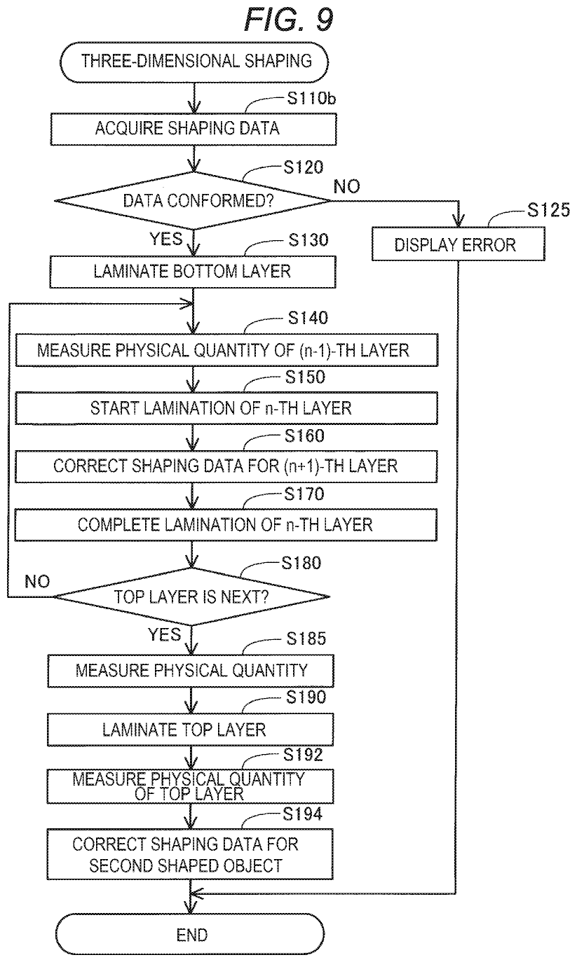

FIG. 9 is an example of a flowchart of three-dimensional shaping for shaping the first shaped object according to another embodiment. As shown in FIG. 9, in another embodiment, the shaping data used for manufacturing the first shaped object may not be used for manufacturing the second shaped object, and the shaping data for the second shaped object may be corrected based on the measurement value of the physical quantity of each layer measured when the first shaped object is manufactured. In FIG. 9, the same steps as those in FIG. 5 are denoted by the same reference numerals as those in FIG. 5. In the example of FIG. 9, in step S110b, the control unit 500 acquires shaping data for shaping the first shaped object and shaping data for shaping the second shaped object. In step S110b, for example, one kind of shaping data common to both the shaped objects may be acquired as the shaping data. After completing the lamination up to a layer immediately below a top layer of the first shaped object, in step S185, the control unit 500 measures a physical quantity of the layer immediately below the top layer of the first shaped object. After the top layer of the first shaped object is laminated in step S190, the control unit 500 further measures a physical quantity of the top layer of the first shaped object in step S192. That is, in the present embodiment, the control unit 500 measures physical quantities of all the layers from the bottom layer to the top layer of the first shaped object.

In step S194, the control unit 500 corrects the shaping data for shaping the second shaped object acquired in step S110b based on a measurement value of the physical quantity of the first shaped object. In the present embodiment, the control unit 500 corrects, based on a measurement value of a physical quantity of a certain layer of the first shaped object, shaping data for a layer of the second shaped object corresponding to the certain layer. For example, the control unit 500 corrects the shaping data for the first layer of the second shaped object based on a difference between a measured shape and a predicted shape of the first layer of the first shaped object, similar to correction of the shaping data for the third layer based on the difference between the measured shape and the predicted shape of the first layer of the first shaped object when the first shaped object is shaped. Similarly, the control unit 500 corrects the shaping data for the third layer of the second shaped object based on, for example, a difference between a measured shape and a predicted shape of the third layer of the first shaped object and a difference between shaping data for the third layer of the first shaped object after correction and shaping data for the third layer of the first shaped object before correction. The same applies to the correction of shaping data for a top layer and a layer immediately below the top layer of the second shaped object.

When the second shaped object is shaped, for example, the control unit 500 executes the three-dimensional shaping in FIG. 8, and acquires, in step S310, the shaping data corrected as described above instead of the shaping data for the first shaped object. For example, the control unit 500 may execute the three-dimensional shaping in FIGS. 5 and 9 to shape the second shaped object. Accordingly, since the shaping data for the layer corresponding to each layer of the second shaped object can be corrected based on the measurement value of the physical quantity of each layer of the first shaped object, it is possible to increase the possibility that the second shaped object can be shaped with higher accuracy than the first shaped object.

### E. Other Embodiments

(E-1) In the above embodiments, in the data processing step, the control unit 500 prepares the shaping data for the (n+1)-th layer, which is a layer immediately after the n-th layer, based on the measurement value of the physical quantity of the (n−1)-th layer. On the other hand, in the data processing step, the control unit 500 may prepare shaping data for a layer that is after the n-th layer by two or more layers, and may, for example, prepare shaping data for an (n+2)-th layer based on the shaping data for the (n−1)-th layer. In addition, in the data processing step, the control unit 500 may prepare shaping data for two or more layers instead of one layer. For example, in the data processing step, the control unit 500 may prepare the shaping data for the (n+1)-th layer and the (n+2)-th layer based on the measurement value of the physical quantity of the (n−1)-th layer.

(E-2) In the above embodiments, the physical quantity acquired in the measurement step includes the dimension, the position, and the temperature of the layer. On the other hand, the physical quantity may include only one or two of the dimension, the position, and the temperature of the layer, or may include, for example, other physical quantities. For example, even when only the temperature is included in the physical quantity, in the correction step or the generation step of the data processing step, the control unit 500 can correct the shaping data for the layer after the current layer or the shape data based on a relation between the temperature and the shape or the dimension of the layer calculated in advance by an experiment or the like.

(E-3) In the above embodiments, the control unit 500 completes the data processing step during the execution of the lamination step. On the other hand, the control unit 500 may not complete the data processing step during the execution of the lamination step. In this case as well, the waiting time until the preparation of the shaping data is completed can be reduced.

(E-4) In the above embodiments, the control unit 500 executes the measurement step at a timing after the completion of the shaping of the (n−1)-th layer and before the start of the shaping of the n-th layer. On the other hand, the control unit 500 may execute the measurement step during the shaping of the (n−1)-th layer, or may execute the measurement step at a timing after the start of the shaping of the n-th layer and before the completion of the shaping of the n-th layer.

(E-5) In the above embodiments, when the correction step is executed in the data processing step, the control unit 500 acquires the shaping data for all the layers before the start of the lamination of the first layer. On the other hand, the control unit 500 may not acquire the shaping data for all the layers before the start of the lamination of the first layer. For example, the control unit 500 may acquire the shaping data for the first layer and the second layer before the start of the lamination of the layers, and may acquire the shaping data for the third and subsequent layers before the correction of the data is executed in the correction step of the data processing step. For example, the control unit 500 may acquire the shaping data for the first layer and the second layer in step S110 of FIG. 5, and may acquire the shaping data for the (n+1)-th layer before executing step S160 in each cycle after the third cycle. In this case, for example, the control unit 500 may execute determination every time the shaping data is acquired, thereby determining whether the layer conforms to the three-dimensional shaping device 100 before shaping the layer. In addition, for example, in the determination of step S120, the control unit 500 may determine whether the shaping data for the first layer or the second layer acquired in step S110 conforms to the three-dimensional shaping device 100, and when the shaping data for the first layer or the second layer conforms to the three-dimensional shaping device 100, the control unit 500 may regard that the shaping data for the other layers also conforms to the three-dimensional shaping device 100.

(E-6) In the second embodiment and the third embodiment, in the generation step of the data processing step, the control unit 500 corrects the entire shape data based on the measurement value of the physical quantity of the (n−1)-th layer. On the other hand, in the generation step, the control unit 500 may correct, instead of the entire shape data, a portion of the shape data indicating the shape of a portion corresponding to the (n+1)-th or more layer based on the measurement value of the physical quantity of the (n−1)-th layer. For example, in step S235 of FIG. 6, the control unit 500 may correct a portion of the shape data acquired in step S205 indicating the shape of a portion corresponding to the (n+1)-th layer based on the measurement value of the physical quantity of the (n−1)-th layer acquired in step S225. Similarly, the control unit 500 may correct, instead of the shape data, the layer data for the (n+1)-th or more layer based on the measurement value of the physical quantity of the (n−1)-th layer.

(E-7) In the above embodiments, the control unit 500 executes the data processing step. On the other hand, the data processing step may be executed by an external computer or the like of the three-dimensional shaping device 100. In this case, in the three-dimensional shaping, the control unit 500 may shape the three-dimensional shaped object while communicating with the external computer. For example, the control unit 500 may transmit the measurement value of the physical quantity of the (n−1)-th layer measured in the measurement step to the external computer, then receive the shaping data for the (n+1)-th or more layer prepared by the external computer executing the data processing step, and shape the layer according to the received shaping data.

(E-8) In the above embodiments, the control unit 500 executes the determination step when the correction step is executed in the data processing step. On the other hand, the control unit 500 may execute the determination step when the generation step is executed in the data processing step. For example, when the three-dimensional shaped object is shaped while communicating with the external computer in the three-dimensional shaping, the control unit 500 may determine, before the lamination step is executed, whether the shaping data generated by the generation step executed by the external computer conforms to the three-dimensional shaping device 100.

(E-9) In the above embodiments, the plasticizing unit 30 of the discharge unit 200 plasticizes the material by a flat screw to generate the shaping material. On the other hand, the plasticizing unit 30 may plasticize the material by, for example, rotating an in-line screw to generate the shaping material. In addition, the discharge unit 200 may be a head that plasticizes a filamentary material and discharges the plasticized material.

(E-10) In the above embodiments, a resin material formed in a pellet shape is used as a raw material to be supplied to the material supply unit 20. On the other hand, the three-dimensional shaping device 100 can shape a three-dimensional shaped object using, as a main material, various materials such as a material having thermoplasticity, a metal material, and a ceramic material. Here, the “main material” indicates a material serving as the center forming the shape of the three-dimensional shaped object, and indicates a material having a content of 50 wt % or more in the three-dimensional shaped object. The above shaping material includes a material obtained by melting the main material alone or a pasty material obtained by melting a part of components contained together with the main material.

When a material having thermoplasticity is used as the main material, the shaping material is generated by plasticizing the material in the plasticizing unit 30. The term “plasticizing” indicates that heat is applied to the material having thermoplasticity to melt the material.

As the material having thermoplasticity, for example, the following thermoplastic resin material can be used.

### Examples of Thermoplastic Resin Material

General-purpose engineering plastics such as polypropylene resin (PP), polyethylene resin (PE), polyacetal resin (POM), polyvinyl chloride resin (PVC), polyamide resin (PA), acrylonitrile-butadiene-styrene resin (ABS), polylactic acid resin (PLA), polyphenylene sulfide resin (PPS), polyether ether ketone (PEEK), polycarbonate (PC), modified polyphenylene ether, polybutylene terephthalate, and polyethylene terephthalate; and engineering plastics such as polysulfone, polyether sulfone, polyphenylene sulfide, polyarylate, polyimide, polyamideimide, polyether imide, and polyether ether ketone

The material having thermoplasticity may be mixed with a pigment, a metal, a ceramic, and other additives such as wax, a flame retardant, an antioxidant, and a heat stabilizer. In the plasticizing unit 30, the material having thermoplasticity is plasticized and converted into a molten state by the rotation of the screw 40 and heating of the heater 58. The shaping material generated by melting the material having thermoplasticity is discharged from the nozzle 61 and then is cured by a decrease in temperature.

It is desirable that the material having thermoplasticity is discharged from the nozzle 61 in a state of being heated to a glass transition point thereof or higher and completely melted. For example, the ABS resin has a glass transition point of about 120° C., and it is desirable that the temperature is about 200° C. at the time of discharge from the nozzle 61.

In the three-dimensional shaping device 100, for example, the following metal material may be used as the main material instead of the above material having thermoplasticity. In this case, it is desirable that a component to be melted at the time of generation of the shaping material is mixed with a powder material obtained by powdering the following metal material, and the mixture is charged into the plasticizing unit 30 as a raw material.

### Examples of Metal Material

Single metals such as magnesium (Mg), iron (Fe), cobalt (Co), chromium (Cr), aluminum (Al), titanium (Ti), copper (Cu), and nickel (Ni), or alloys containing one or more of these metals

### Examples of the Alloy

Maraging steel, stainless steel, cobalt chromium molybdenum, titanium alloy, nickel alloy, aluminum alloy, cobalt alloy, and cobalt chromium alloy

In the three-dimensional shaping device 100, a ceramic material can be used as the main material instead of the above metal materials. Examples of the ceramic material include oxide ceramics such as silicon dioxide, titanium dioxide, aluminum oxide, and zirconium oxide, and non-oxide ceramics such as aluminum nitride. When the above metal material or the ceramic material is used as the main material, the shaping material disposed on the stage 300 may be cured by laser irradiation or sintering by warm air or the like.

The powder material of the metal material or the ceramic material to be charged into the material supply unit 20 as a raw material may be a mixed material obtained by mixing a plurality of kinds of powder of a single metal, powder of an alloy, and powder of a ceramic material. The powder material of the metal material or the ceramic material may be coated with, for example, a thermoplastic resin as exemplified above or another thermoplastic resin. In this case, the thermoplastic resin may be melted by the plasticizing unit 30 to exhibit fluidity.

For example, the following solvent may be added to the powder material of the metal material or the ceramic material which is charged into the material supply unit 20 as a raw material. As the solvent, one kind or a combination of two or more kinds selected from the following solvent may be used.

### Examples of Solvent

Water; (poly)alkylene glycol monoalkyl ethers such as ethylene glycol monomethyl ether, ethylene glycol monoethyl ether, propylene glycol monomethyl ether, and propylene glycol monoethyl ether; acetic acid esters such as ethyl acetate, n-propyl acetate, iso-propyl acetate, n-butyl acetate, and iso-butyl acetate; aromatic hydrocarbons such as benzene, toluene, and xylene; ketones such as methyl ethyl ketone, acetone, methyl isobutyl ketone, ethyl-n-butyl ketone, diisopropyl ketone, and acetylacetone; alcohols such as ethanol, propanol, and butanol; tetraalkylammonium acetates; sulfoxide-based solvents such as dimethyl sulfoxide and diethyl sulfoxide; pyridine-based solvents such as pyridine, γ-picoline, and 2,6-lutidine; tetraalkylammonium acetates (for example, tetrabutylammonium acetate); ionic liquids such as butyl carbitol acetate

In addition, for example, the following binder may be added to the powder material of the metal material or the ceramic material which is charged into the material supply unit 20 as a raw material.

### Examples of Binder

Acrylic resin, epoxy resin, silicone resin, cellulose-based resin, or other synthetic resins, or polylactic acid (PLA), polyamide (PA), polyphenylene sulfide (PPS), polyether ether ketone (PEEK), or other thermoplastic resins

### F. Other Aspects:

The present disclosure is not limited to the embodiments described above, and can be implemented in various aspects without departing from the scope of the present disclosure. For example, the present disclosure can also be implemented by the following aspects. In order to solve a part or all of problems of the present disclosure, or to achieve a part or all of effects of the present disclosure, technical features of the above embodiments corresponding to technical features in the following aspects can be replaced or combined as appropriate. Any of the technical features may be omitted as appropriate unless the technical feature is described as essential in the present description.

(1) According to the first aspect of the present disclosure, there is provided a method for manufacturing a three-dimensional shaped object of shaping a three-dimensional shaped object by discharging a shaping material from a discharge unit provided in a three-dimensional shaping device to laminate a plurality of layers according to shaping data for shaping the three-dimensional shaped object layer by layer. The shaping data is generated based on shape data indicating a shape of the three-dimensional shaped object. The method for manufacturing a three-dimensional shaped object includes: a first lamination step of laminating an n-th layer, n being any integer of 2 or more; a measurement step of measuring a physical quantity of an (n−1)-th layer; a data processing step of preparing shaping data for an (n+1)-th or more layer; and a second lamination step of laminating the (n+1)-th or more layer according to the shaping data prepared in the data processing step. The data processing step includes executing a correction step of preparing the shaping data for the (n+1)-th or more layer by correcting shaping data generated in advance based on the physical quantity, or a generation step of generating the shaping data for the (n+1)-th or more layer based on the physical quantity and the shape data.

According to such an aspect, since the n-th layer can be shaped during the preparation of the shaping data for the (n+1)-th or more layer, the waiting time until the preparation of the shaping data is completed can be reduced as compared with when shaping data for the n-th layer is prepared based on a measurement value of the physical quantity of the (n−1)-th layer. Therefore, it is possible to increase the possibility that the three-dimensional shaped object can be shaped with high accuracy, and to prevent prolongation of the shaping time.

(2) In the above aspect, the physical quantity may include at least one of a dimension, a position, or a temperature of a layer. According to such an aspect, the shaping data for the (n+1)-th or more layer can be prepared based on at least one of a dimension, a position, and a temperature of the (n−1)th layer.

(3) In the above aspect, the data processing step may be completed during execution of the first lamination step. According to such an aspect, the waiting time until the preparation of the shaping data is completed can be further reduced, and the prolongation of the shaping time can be further prevented.

(4) In the above aspect, the data processing step may include executing the generation step. The generation step may include correcting the shape data based on the physical quantity, generating layer data indicating a shape obtained by slicing the shape of the three-dimensional shaped object into layers based on the corrected shape data, and generating the shaping data for the (n+1)-th or more layer based on the generated layer data. According to such an aspect, since the shape data is corrected based on the measurement value of the physical quantity, it is possible to further increase the possibility that shaping data capable of shaping a three-dimensional shaped object having a desired shape can be prepared.

(5) In the above aspect, the generation step may include determining a thickness of the shape indicated by the layer data based on the physical quantity. According to such an aspect, it is possible to further improve the shaping accuracy in a direction in which the layers of the three-dimensional shaped object are laminated.

(6) In the above aspect, the data processing step may include executing the generation step. The generation step may include determining a shaping condition for the (n+1)-th or more layer based on the physical quantity, and generating the shaping data for the (n+1)-th or more layer based on the determined shaping condition and the shape data. According to such an aspect, the shaping condition can be changed based on the measurement value of the physical quantity, and the three-dimensional shaped object can be shaped with high accuracy under the changed shaping condition.

(7) The above aspect may further include determining, before the first lamination step is executed, whether the shaping data conforms to the three-dimensional shaping device. According to such an aspect, the three-dimensional shaped object can be shaped using the shaping data conforming to the three-dimensional shaping device.

(8) In the above aspect, the data processing step may include preparing shaping data for one layer as the shaping data for the (n+1)-th or more layer. According to such an aspect, the waiting time until the preparation of the shaping data is completed can be reduced as compared with when the shaping data for a plurality of layers is prepared in one data processing step.

(9) In the above aspect, a first shaped object and a second shaped object that has a shape corresponding to the first shaped object and that is manufactured after completion of manufacturing of the first shaped object may be manufactured as the three-dimensional shaped object. The shaping data used for manufacturing the first shaped object may be used for manufacturing the second shaped object. According to such an aspect, it is possible to increase the possibility that the second shaped object can be manufactured with high accuracy as compared with when the second shaped object is manufactured without using the shaping data for the first shaped object.

(10) According to the second aspect of the present disclosure, there is provided a three-dimensional shaping device. The three-dimensional shaping device includes: a stage; a discharge unit configured to discharge a shaping material toward the stage; a position change unit configured to change a relative position between the discharge unit and the stage; a control unit configured to control the discharge unit and the position change unit according to shaping data for shaping a three-dimensional shaped object layer by layer, the shaping data being generated based on shape data indicating a shape of the three-dimensional shaped object, and configured to shape the three-dimensional shaped object on the stage by discharging the shaping material from the discharge unit to laminate a plurality of layers; and a measurement unit configured to measure a physical quantity of the layers laminated on the stage. The control unit executes a first lamination step of laminating an n-th layer, n being any integer of 2 or more, a measurement step of measuring a physical quantity of an (n−1)-th layer by the measurement unit, a data processing step of preparing shaping data for an (n+1)-th or more layer, and a second lamination step of laminating the (n+1)-th or more layer according to the shaping data prepared in the data processing step. In the data processing step, the control unit executes a correction step of preparing the shaping data for the (n+1)-th or more layer by correcting shaping data generated in advance based on the physical quantity, or a generation step of generating the shaping data for the (n+1)-th or more layer based on the physical quantity and the shape data. According to such an aspect, since the n-th layer can be shaped during the preparation of the shaping data for the (n+1)-th or more layer, the waiting time until the preparation of the shaping data is completed can be reduced as compared with when shaping data for the n-th layer is prepared based on a measurement value of the physical quantity of the (n−1)-th layer. Therefore, it is possible to increase the possibility that the three-dimensional shaped object can be shaped with high accuracy, and prolongation of the shaping time can be prevented.

What is claimed is:

1. A method for manufacturing a three-dimensional shaped object of shaping a three-dimensional shaped object by discharging a shaping material from a discharge unit provided in a three-dimensional shaping device to laminate a plurality of layers according to shaping data for shaping the three-dimensional shaped object layer by layer, the shaping data being generated based on shape data indicating a shape of the three-dimensional shaped object, the method for manufacturing a three-dimensional shaped object comprising:
a first lamination step of laminating an n-th layer, n being any integer of 2 or more;
a measurement step of measuring a physical quantity of an (n−1)-th layer;
a data processing step of preparing the shaping data for an (n+1)-th or more layer; and
a second lamination step of laminating the (n+1)-th or more layer according to the shaping data prepared in the data processing step, wherein
the data processing step includes executing
a correction step of preparing the shaping data for the (n+1)-th or more layer by correcting the shaping data generated in advance based on the physical quantity, or
a generation step of generating the shaping data for the (n+1)-th or more layer based on the physical quantity and the shape data.

2. The method for manufacturing a three-dimensional shaped object according to claim 1, wherein
the physical quantity includes at least one of a dimension, a position, or a temperature of a layer.

3. The method for manufacturing a three-dimensional shaped object according to claim 1, wherein
the data processing step is completed during execution of the first lamination step.

4. The method for manufacturing a three-dimensional shaped object according to claim 1, wherein
the data processing step includes executing the generation step, and
the generation step includes
correcting the shape data based on the physical quantity,
generating layer data indicating a shape obtained by slicing the shape of the three-dimensional shaped object into layers based on the corrected shape data, and
generating the shaping data for the (n+1)-th or more layer based on the generated layer data.

5. The method for manufacturing a three-dimensional shaped object according to claim 4, wherein
the generation step includes determining a thickness of the shape indicated by the layer data based on the physical quantity.

6. The method for manufacturing a three-dimensional shaped object according to claim 1, wherein
the data processing step includes executing the generation step, and
the generation step includes
determining a shaping condition for the (n+1)-th or more layer based on the physical quantity, and
generating the shaping data for the (n+1)-th or more layer based on the determined shaping condition and the shape data.

7. The method for manufacturing a three-dimensional shaped object according to claim 1, further comprising:
determining, before the first lamination step is executed, whether the shaping data conforms to the three-dimensional shaping device.

8. The method for manufacturing a three-dimensional shaped object according to claim 1, wherein
the data processing step includes preparing the shaping data for one layer as the shaping data for the (n+1)-th or more layer.

9. The method for manufacturing a three-dimensional shaped object according to claim 1, wherein
a first shaped object and a second shaped object that has a shape corresponding to the first shaped object and that is manufactured after completion of manufacturing of the first shaped object are manufactured as the three-dimensional shaped object, and
the shaping data used for manufacturing the first shaped object is used for manufacturing the second shaped object.

10. A three-dimensional shaping device comprising:
a stage;
a discharge unit configured to discharge a shaping material toward the stage;
a position change unit configured to change a relative position between the discharge unit and the stage;
a control unit configured to control the discharge unit and the position change unit according to shaping data for shaping a three-dimensional shaped object layer by layer, the shaping data being generated based on shape data indicating a shape of the three-dimensional shaped object, and configured to shape the three-dimensional shaped object on the stage by discharging the shaping material from the discharge unit to laminate a plurality of layers; and
a measurement unit configured to measure a physical quantity of the layers laminated on the stage, wherein
the control unit executes
a first lamination step of laminating an n-th layer, n being any integer of 2 or more,
a measurement step of measuring a physical quantity of an (n−1)-th layer by the measurement unit,
a data processing step of preparing the shaping data for an (n+1)-th or more layer, and
a second lamination step of laminating the (n+1)-th or more layer according to the shaping data prepared in the data processing step, and
in the data processing step, the control unit executes
a correction step of preparing the shaping data for the (n+1)-th or more layer by correcting the shaping data generated in advance based on the physical quantity, or
a generation step of generating the shaping data for the (n+1)-th or more layer based on the physical quantity and the shape data.
